(19) United States
(12) Patent Application Publication
(10) Pub. No.: US 2016/0218630 A1
(43) Pub. Date: Jul. 28, 2016

(54) FREQUENCY CONTROLLER OF A POWER CONVERTER AND RELATED FREQUENCY CONTROL METHOD

(71) Applicant: Leadtrend Technology Corp., Hsin-Chu (TW)

(72) Inventors: Jiun-Sheng Huang, Hsin-Chu (TW); Ming-Chang Tsou, Hsin-Chu (TW)

(21) Appl. No.: 14/994,144

(22) Filed: Jan. 13, 2016

(30) Foreign Application Priority Data
Jan. 22, 2015 (TW) 104102110

(51) Int. Cl. H02M 3/335

(52) U.S. Cl. CPC H02M 3/33515

(57) ABSTRACT

A frequency controller of a power converter includes a valley signal generation unit, a valley selection module, and a gate signal generation unit. The valley signal generation unit generates a valley signal corresponding to a voltage according to the voltage and a reference voltage. The valley selection module generates a valley selection signal according to a gate control signal, a compensation voltage, and the valley signal. The gate signal generation unit generates the gate control signal according to the valley signal, the valley selection signal, the compensation voltage, and a detection voltage. A frequency of the gate control signal is changed with a load of a secondary side of the power converter and a corresponding valley of the voltage within each period of the gate control signal.

### BACKGROUND OF THE INVENTION

1. Field of the Invention

The present invention relates to a frequency controller of a power converter and a related frequency control method, and particularly to a frequency controller of a power converter and a related frequency control method that can utilize a valley selection signal to make a frequency of a gate control signal of the power converter be adjusted gradually to be between a reference frequency upper limit and a reference frequency lower limit.

2. Description of the Prior Art

When a light load is coupled to a secondary side of a power converter, a frequency controller provided by the prior art utilizes a delay unit to insert a blanking time to reduce a frequency of a gate control signal of the power converter, resulting in switching loss of the power converter being also reduced with the frequency of the gate control signal, wherein the blanking time can be changed with the load coupled to the secondary side of the power converter. The above mentioned method of inserting the blanking time to reduce the frequency of the gate control signal of the power converter forces the power converter to execute valley switching when the power converter is in a quasi resonant mode after the blanking time. Therefore, the frequency of the gate control signal (that is, a maximum switching frequency of the power converter) of the power converter will be limited by the blanking time. That is to say, the above mentioned method forces the power converter to execute the valley switching at a valley next to the blanking time after the blanking time.

However, because the prior art forces the power converter to execute the valley switching at the valley next to the blanking time after the blanking time, the power converter may execute the valley switching at different valleys during each period of the power converter (e.g. the power converter executes the valley switching at a first valley during a previous period of the power converter, the power converter executes the valley switching at a second valley during a current period of the power converter, and so on) when the blanking time is completed near a valley. Thus, because the power converter may execute the valley switching at different valleys during each period of the power converter, a difference frequency may exist between two consecutive periods of the power converter. If the difference frequency falls within a human hearing range, a user may hear noise caused by the difference frequency. Therefore, the prior art is not a good choice for the user.

### SUMMARY OF THE INVENTION

An embodiment of the present invention provides a frequency controller of a power converter. The frequency controller includes a valley signal generation unit, a valley selection module, and a gate signal generation unit. The valley signal generation unit is used for generating a valley signal corresponding to a voltage according to the voltage and a reference voltage. The valley selection module is used for generating a valley selection signal according to agate control signal, a compensation voltage, and the valley signal. The gate signal generation unit is used for generating the gate control signal according to the valley signal, the valley selection signal, the compensation voltage, and a detection voltage, wherein a frequency of the gate control signal is changed with a corresponding valley of the voltage within each period of the gate control signal, and the corresponding valley is changed with a load of a secondary side of the power converter.

Another embodiment of the present invention provides a frequency control method of a power converter, wherein a frequency controller applied to the frequency control method includes a valley signal generation unit, a valley selection module, and a gate signal generation unit, and the valley selection module includes a reference frequency upper limit/lower limit generation unit and a valley selector. The frequency control method includes the valley signal generation unit generating a valley signal corresponding to a voltage according to the voltage and a reference voltage; the valley selection module generating a valley selection signal according to a gate control signal, a compensation voltage, and the valley signal; and the gate signal generation unit generating the gate control signal according to the valley signal, the valley selection signal, the compensation voltage, and a detection voltage, wherein a frequency of the gate control signal is changed with a corresponding valley of the voltage within each period of the gate control signal, and the corresponding valley is changed with a load of a secondary side of the power converter.

The present invention provides a frequency controller of a power converter and a frequency control method of a power converter. The frequency controller and the frequency control method utilize a valley signal generation unit to generate a valley signal, utilize a reference frequency upper limit/lower limit generation unit of a valley selection module to generate a reference frequency upper limit and a reference frequency lower limit changed with a compensation voltage according to a gate control signal and the compensation voltage, utilize a valley selector of the valley selection module to generate a valley selection signal according to the reference frequency upper limit, the reference frequency lower limit, the valley signal, and the gate control signal, and utilize a gate signal generation unit to generate the gate control signal according to the valley signal, the valley selection signal, the compensation voltage, and a detection voltage. Because the valley selector generates the valley selection signal according to the reference frequency upper limit, the reference frequency lower limit, the valley signal, and the gate control signal, a frequency of the gate control signal generated by the gate signal generation unit can be adjusted gradually to be between the reference frequency upper limit and the reference frequency lower limit. Because the frequency of the gate control signal generated by the gate signal generation unit can be adjusted gradually to be between the reference frequency upper limit and the reference frequency lower limit, the present invention can solve a noise problem generated by the prior art when a light load is coupled to the power converter.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a frequency controller applied to a power converter according to a first embodiment of the present invention.

FIG. 2 is a diagram illustrating the compensation voltage, the voltage, the gate control signal, a detection voltage received by the current detection pin, the valley signal, and the valley selection signal when the load of the secondary side of the power converter is changed from heavy to light.

FIG. 3 is a diagram illustrating the compensation voltage, the voltage, the gate control signal, the detection voltage, the valley signal, and the valley selection signal when the load of the secondary side of the power converter is changed from light to heavy.

FIG. 4 is a flowchart illustrating a frequency control method of a power converter according to a second embodiment of the present invention.

### DETAILED DESCRIPTION

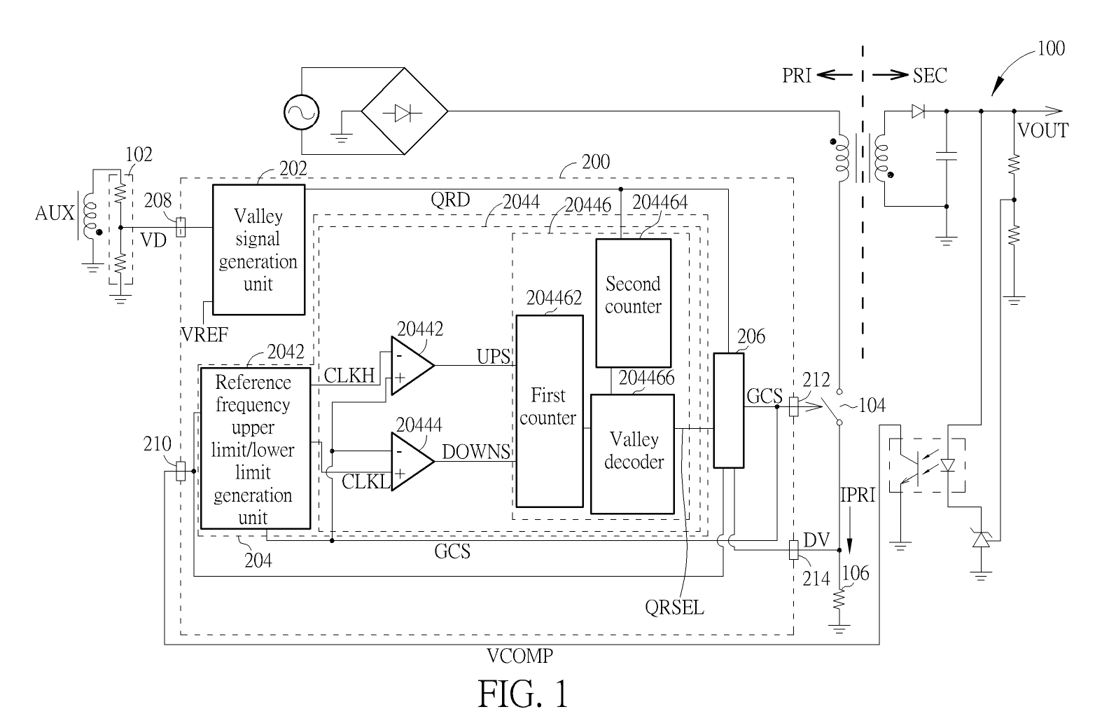

Please refer to FIG. 1. FIG. 1 is a diagram illustrating a frequency controller 200 applied to a power converter 100 according to a first embodiment of the present invention. As shown in FIG. 1, the frequency controller 200 includes a valley signal generation unit 202, a valley selection module 204, a gate signal generation unit 206, an auxiliary pin 208, a compensation pin 210, a gate pin 212, and a current detection pin 214. As shown in FIG. 1, the valley signal generation unit 202 is used for generating a valley signal QRD corresponding to a voltage VD according to the voltage VD received by the auxiliary pin 208 and a reference voltage VREF, wherein the voltage VD corresponds to an auxiliary winding AUX of a primary side PRI of the power converter 100, and is generated by a voltage divider 102 coupled to the auxiliary winding AUX. As shown in FIG. 1, the valley selection module 204 includes a reference frequency upper limit/lower limit generation unit 2042 and a valley selector 2044, wherein the valley selector 2044 is coupled to the reference frequency upper limit/lower limit generation unit 2042 and the valley signal generation unit 202, and the valley selector 2044 includes a first comparator 20442, a second comparator 20444, and a valley selection signal generation unit 20446. In addition, the valley selection signal generation unit 20446 includes a first counter 204462, a second counter 204464, and a valley decoder 204466.

As shown in FIG. 1, the reference frequency upper limit/lower limit generation unit 2042 is used for generating a reference frequency upper limit CLKH and a reference frequency lower limit CLKL according to a gate control signal GCS generated by the gate signal generation unit 206 and a compensation voltage VCOMP received by the compensation pin 210, wherein the compensation voltage VCOMP corresponds to an output voltage VOUT of a secondary side SEC of the power converter 100 (that is, the compensation voltage VCOMP corresponds to a load of the secondary side SEC of the power converter 100), and the reference frequency upper limit CLKH and the reference frequency lower limit CLKL are changed with the compensation voltage VCOMP. As shown in FIG. 1, the valley selector 2044 is coupled to the reference frequency upper limit/lower limit generation unit 2042 and the valley signal generation unit 202. The first comparator 20442 of the valley selector 2044 is used for generating an upward counting signal UPS according to the reference frequency upper limit CLKH and a frequency of the gate control signal GCS; and the second comparator 20444 of the valley selector 2044 is used for generating a downward counting signal DOWNS according to the reference frequency lower limit CLKL and the frequency of the gate control signal GCS. In addition, the valley selection signal generation unit 20446 of the valley selector 2044 is coupled to the first comparator 20442, the second comparator 20444, and the valley signal generation unit 202 for generating a valley selection signal QRSEL according to the upward counting signal UPS and a number of the valley signal QRD, the downward counting signal DOWNS and the number of the valley signal QRD, or a current count and the number of the valley signal QRD, wherein the current count is generated by the first counter 204462 and the number of the valley signal QRD is generated by the second counter 204464.

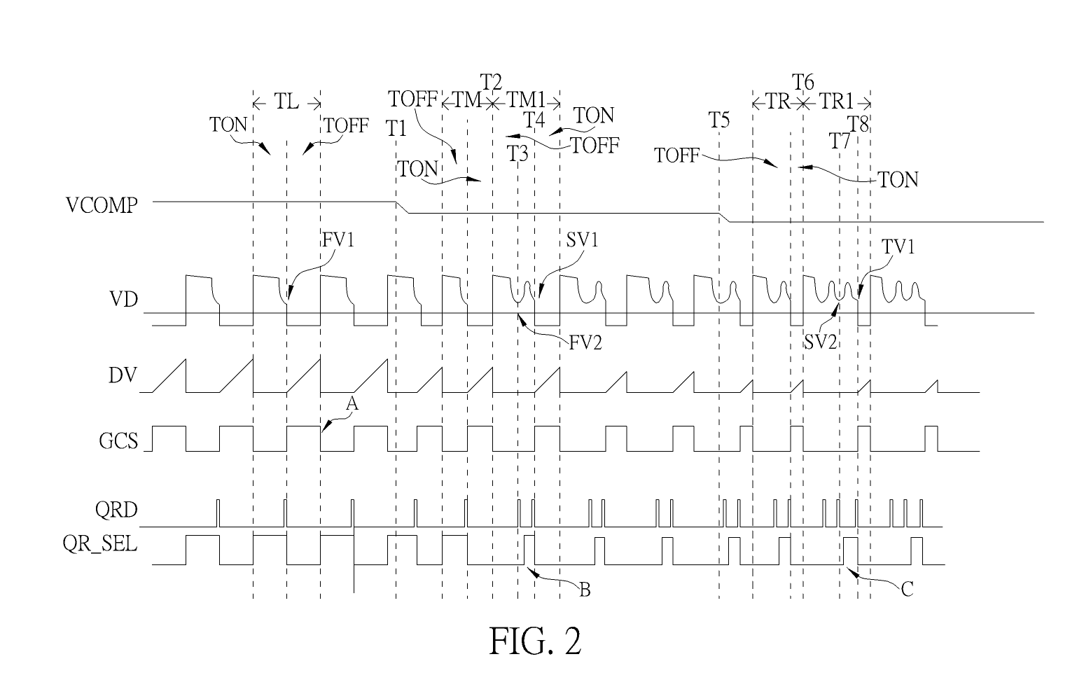

Please refer to FIG. 2. FIG. 2 is a diagram illustrating the compensation voltage VCOMP, the voltage VD, the gate control signal GCS, a detection voltage DV received by the current detection pin 214, the valley signal QRD, and the valley selection signal QRSEL when the load of the secondary side SEC of the power converter 100 is changed from heavy to light. As shown in FIG. 1 and FIG. 2, before a time T1, the load of the secondary side SEC of the power converter 100 is kept heavy. Meanwhile, the gate signal generation unit 206 can enable the gate control signal GCS at a first valley FV1 of the voltage VD within a period TL of the gate control signal GCS according to the valley signal QRD and the valley selection signal QRSEL, and when the detection voltage DV is greater than or equal to the compensation voltage VCOMP, the gate signal generation unit 206 can disable the gate control signal GCS within the period TL of the gate control signal GCS (a position A shown in FIG. 2) according to the compensation voltage VCOMP and the detection voltage DV, wherein the detection voltage DV is determined by a current IPRI flowing through a power switch 104 of the primary side PRI of the power converter 100 and a resistor 106, and the gate control signal GCS is transmitted to the power switch 104 of the primary side PRI of the power converter 100 through the gate pin 212. Because the gate signal generation unit 206 can enable the gate control signal GCS at the first valley FV1 of the voltage VD within the period TL of the gate control signal GCS according to the valley signal QRD and the valley selection signal QRSEL, and disable the gate control signal GCS within the period TL of the gate control signal GCS according to the compensation voltage VCOMP and the detection voltage DV, the gate signal generation unit 206 can determine a turning-on time TON and a turning-off time TOFF of the gate control signal GCS corresponding to the period TL of the gate control signal GCS. That is to say, the gate signal generation unit 206 can generate the gate control signal GCS according to the valley signal QRD, the valley selection signal QRSEL, the compensation voltage VCOMP, and the detection voltage DV.

As shown in FIG. 2, at the time T1, the load of the secondary side SEC of the power converter 100 is decreased, so the compensation voltage VCOMP is also decreased with the load of the secondary side SEC of the power converter 100. Because the load of the secondary side SEC of the power converter 100 is decreased, a sum of a turning-on time TON and a turning-off time TOFF corresponding to a period TM of the gate control signal GCS is less than a sum of the turning-on time TON and the turning-off time TOFF corresponding to the period TL of the gate control signal GCS. That is to say, after the time T1, the frequency of the gate control signal GCS is increased and exceeds the reference frequency upper limit CLKH, resulting in the first comparator 20442 of the valley selector 2044 generating the upward counting signal UPS. Therefore, the first counter 204462 can count upward once according to the upward counting signal UPS (meanwhile, a number stored in the first counter 204462 is “2”). After a time T2, because the number stored in the first counter 204462 is “2”, the valley decoder 204466 can generate the valley selection signal QRSEL (a position B shown in FIG. 2) after a first valley FV2 (corresponding to a time T3) of the voltage VD. That is to say, after the time T3, the valley decoder 204466 can generate the valley selection signal QRSEL after the first valley FV2 of the voltage VD according to a number “1” (corresponding to the first valley FV2 of the voltage VD) of the valley signal QRD recoded by the second counter 204464 and the number “2” stored in the first counter 204462. Because the valley decoder 204466 can generate the valley selection signal QRSEL after the first valley FV2 of the voltage VD, the gate signal generation unit 206 can enable the gate control signal GCS at a time T4 (corresponding to a second valley SV1 of the voltage VD) according to the valley signal QRD and the valley selection signal QRSEL. Because the gate signal generation unit 206 can enable the gate control signal GCS at the second valley SV1 (corresponding to the time T4) of the voltage VD according to the valley signal QRD and the valley selection signal QRSEL, a turning-off time TOFF corresponding to a period TM1 of the gate control signal GCS is increased. That is to say, the frequency of the gate control signal GCS will be less than the reference frequency upper limit CLKH after the time T2. However, after the time T2, if the frequency of the gate control signal GCS is still greater than the reference frequency upper limit CLKH, the frequency controller 200 can execute the above mentioned steps repeatedly until the frequency of the gate control signal GCS is less than the reference frequency upper limit CLKH.

Similarly, as shown in FIG. 2, at a time T5, the load of the secondary side SEC of the power converter 100 is decreased again, so the compensation voltage VCOMP is also decreased with the load of the secondary side SEC of the power converter 100 again. Because the load of the secondary side SEC of the power converter 100 is decreased again, a sum of a turning-on time TON and a turning-off time TOFF corresponding to a period TR of the gate control signal GCS is less than a sum of a turning-on time TON and the turning-off time TOFF corresponding to the period TM1 of the gate control signal GCS. That is to say, after the time T5, the frequency of the gate control signal GCS is increased and exceeds the reference frequency upper limit CLKH again, resulting in the first comparator 20442 of the valley selector 2044 generating the upward counting signal UPS again. Therefore, the first counter 204462 can count upward once again according to the upward counting signal UPS (meanwhile, the number stored in the first counter 204462 is “3”). After a time T6, because the number stored in the first counter 204462 is “3”, the valley decoder 204466 can generate the valley selection signal QRSEL (a position C shown in FIG. 2) after a second valley SV2 (corresponding to a time T7) of the voltage VD. That is to say, after the time T7, the valley decoder 204466 can generate the valley selection signal QRSEL after the second valley SV2 of the voltage VD according to the number “2” (corresponding to the second valley SV2 of the voltage VD) of the valley signal QRD recoded by the second counter 204464 and the number “3” stored in the first counter 204462. Because the valley decoder 204466 can generate the valley selection signal QRSEL after the second valley SV2 of the voltage VD, the gate signal generation unit 206 can enable the gate control signal GCS at a time T8 (corresponding to a third valley TV1 of the voltage VD) according to the valley signal QRD and the valley selection signal QRSEL. Because the gate signal generation unit 206 can enable the gate control signal GCS at the third valley TV1 (corresponding to the time T8) of the voltage VD according to the valley signal QRD and the valley selection signal QRSEL, a turning-off time TOFF corresponding to a period TR1 of the gate control signal GCS is increased. That is to say, the frequency of the gate control signal GCS will be less than the reference frequency upper limit CLKH after the time T6. However, after the time T6, if the frequency of the gate control signal GCS is still greater than the reference frequency upper limit CLKH, the frequency controller 200 can execute the above mentioned steps repeatedly until the frequency of the gate control signal GCS is less than the reference frequency upper limit CLKH.

In addition, as shown in FIG. 2, when the load of the secondary side SEC of the power converter 100 is unchanged, the frequency of the gate control signal GCS is between the reference frequency upper limit CLKH and the reference frequency lower limit CLKL. Meanwhile, the valley decoder 204466 can generate the valley selection signal QRSEL according to a current count stored in the first counter 204462 and the number of the valley signal QRD recoded by the second counter 204464. For example, after the time T4 shown in FIG. 2, if the load of the secondary side SEC of the power converter 100 is unchanged, the frequency of the gate control signal GCS is between the reference frequency upper limit CLKH and the reference frequency lower limit CLKL. Because the frequency of the gate control signal GCS is between the reference frequency upper limit CLKH and the reference frequency lower limit CLKL, the valley decoder 204466 can generate the valley selection signal QRSEL after the first valley of the voltage VD according to the current count (that is, a number “2”) stored in the first counter 204462 and the number “1” (corresponding to the first valley of the voltage VD) of the valley signal QRD recoded by the second counter 204464.

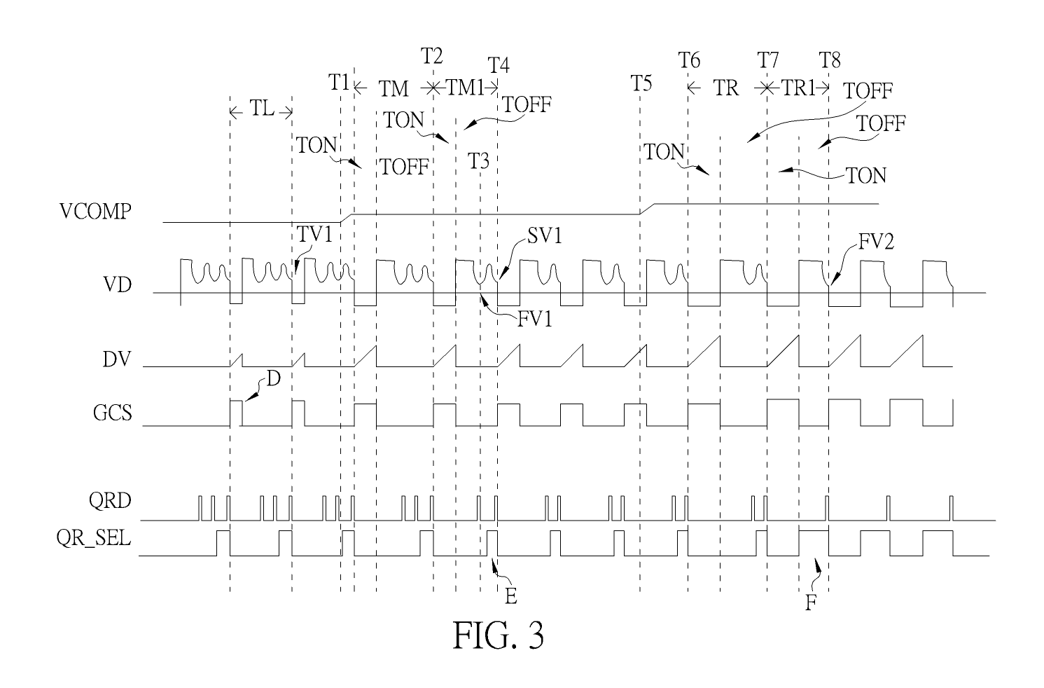

Please refer to FIG. 3. FIG. 3 is a diagram illustrating the compensation voltage VCOMP, the voltage VD, the gate control signal GCS, the detection voltage DV, the valley signal QRD, and the valley selection signal QRSEL when the load of the secondary side SEC of the power converter 100 is changed from light to heavy. As shown in FIG. 1 and FIG. 3, before a time T1, the load of the secondary side SEC of the power converter 100 is kept light. Meanwhile, the gate signal generation unit 206 can enable the gate control signal GCS at a third valley TV1 of the voltage VD corresponding to a period TL of the gate control signal GCS according to the valley signal QRD and the valley selection signal QRSEL, and when the detection voltage DV is greater than or equal to the compensation voltage VCOMP, the gate signal generation unit 206 can disable the gate control signal GCS within the period TL of the gate control signal GCS (a position D shown in FIG. 3) according to the compensation voltage VCOMP and the detection voltage DV.

As shown in FIG. 3, at the time T1, the load of the secondary side SEC of the power converter 100 is increased, so the compensation voltage VCOMP is also increased with the load of the secondary side SEC of the power converter 100. Because the load of the secondary side SEC of the power converter 100 is increased, a sum of a turning-on time TON and a turning-off time TOFF corresponding to a period TM of the gate control signal GCS is greater than a sum of a turning-on time TON and a turning-off time TOFF corresponding to the period TL of the gate control signal GCS. That is to say, after the time T1, the frequency of the gate control signal GCS is decreased and lower than the reference frequency lower limit CLKL, resulting in the second comparator 20444 of the valley selector 2044 generating the downward counting signal DOWNS. Therefore, the first counter 204462 can count downward once according to the downward counting signal DOWNS (before the time T1, because the gate signal generation unit 206 enables the gate control signal GCS at the third valley TV1 of the voltage VD, meanwhile, the number stored in the first counter 204462 is changed from “3” to “2”). After a time T2, because the number stored in the first counter 204462 is “2”, the valley decoder 204466 can generate the valley selection signal QRSEL (a position E shown in FIG. 3) after a first valley FV1 of the voltage VD (corresponding to a time T3). That is to say, after the time T3, the valley decoder 204466 can generate the valley selection signal QRSEL according to a number “1” (corresponding to the first valley FV1 of the voltage VD) of the valley signal QRD recoded by the second counter 204464 and the number “2” stored in the first counter 204462. Because the valley decoder 204466 can generate the valley selection signal QRSEL after the first valley FV1 of the voltage VD, the gate signal generation unit 206 can enable the gate control signal GCS at a time T4 (corresponding to a second valley SV1 of the voltage VD) according to the valley signal QRD and the valley selection signal QRSEL. Because the gate signal generation unit 206 can enable the gate control signal GCS at the second valley SV1 (corresponding to the time T4) of the voltage VD according to the valley signal QRD and the valley selection signal QRSEL, a turning-off time TOFF corresponding to a period TM1 of the gate control signal GCS is decreased. That is to say, the frequency of the gate control signal GCS will be greater than the reference frequency lower limit CLKL after the time T2. However, after the time T2, if the frequency of the gate control signal GCS is still less than the reference frequency lower limit CLKL, the frequency controller 200 can execute the above mentioned steps repeatedly until the frequency of the gate control signal GCS is greater than the reference frequency lower limit CLKL.

Similarly, as shown in FIG. 3, at a time T5, the load of the secondary side SEC of the power converter 100 is increased again, so the compensation voltage VCOMP is also increased with the load of the secondary side SEC of the power converter 100 again. Because the load of the secondary side SEC of the power converter 100 is increased again, a sum of a turning-on time TON and a turning-off time TOFF corresponding to a period TR of the gate control signal GCS is greater than a sum of a turning-on time TON and the turning-off time TOFF corresponding to the period TM1 of the gate control signal GCS. That is to say, after the time T6, the frequency of the gate control signal GCS is decreased and lower than the reference frequency lower limit CLKL again, resulting in the second comparator 20444 of the valley selector 2044 generating the downward counting signal DOWNS again. Therefore, the first counter 204462 can count downward once again according to the downward counting signal DOWNS (meanwhile, the number stored in the first counter 204462 is “1”). After a time T7, because the number stored in the first counter 204462 is “1”, the valley decoder 204466 can generate the valley selection signal QRSEL (a position F shown in FIG. 3) before a first valley FV2 (corresponding to a time T8) of the voltage VD. That is to say, after the time T7, the valley decoder 204466 can generate the valley selection signal QRSEL according to the number “0” of the valley signal QRD recoded by the second counter 204464 and the number “1” stored in the first counter 204462. Therefore, at the time T8 (corresponding to the first valley FV2 of the voltage VD), the gate signal generation unit 206 can enable the gate control signal GCS according to the valley signal QRD and the valley selection signal QRSEL. Because the gate signal generation unit 206 can enable the gate control signal GCS at the first valley FV2 (corresponding to the time T8) of the voltage VD according to the valley signal QRD and the valley selection signal QRSEL, a turning-off time TOFF corresponding to a period TR1 of the gate control signal GCS is decreased. That is to say, the frequency of the gate control signal GCS will be greater than the reference frequency lower limit CLKL after the time T8. However, after the time T8, if the frequency of the gate control signal GCS is still less than the reference frequency lower limit CLKL, the frequency controller 200 can execute the above mentioned steps repeatedly until the frequency of the gate control signal GCS is greater than the reference frequency lower limit CLKL.

In addition, as shown in FIG. 3, when the load of the secondary side SEC of the power converter 100 is unchanged, the frequency of the gate control signal GCS is between the reference frequency upper limit CLKH and the reference frequency lower limit CLKL. Meanwhile, the valley decoder 204466 can generate the valley selection signal QRSEL according to a current count stored in the first counter 204462 and the number of the valley signal QRD recoded by the second counter 204464. For example, after the time T4 shown in FIG. 3, if the load of the secondary side SEC of the power converter 100 is unchanged, the frequency of the gate control signal GCS is between the reference frequency upper limit CLKH and the reference frequency lower limit CLKL. Because the frequency of the gate control signal GCS is between the reference frequency upper limit CLKH and the reference frequency lower limit CLKL, the valley decoder 204466 can generate the valley selection signal QRSEL after the first valley of the voltage VD according to the current count (that is, a number “2”) stored in the first counter 204462 and the number “1” (corresponding to the first valley of the voltage VD) of the valley signal QRD recoded by the second counter 204464.

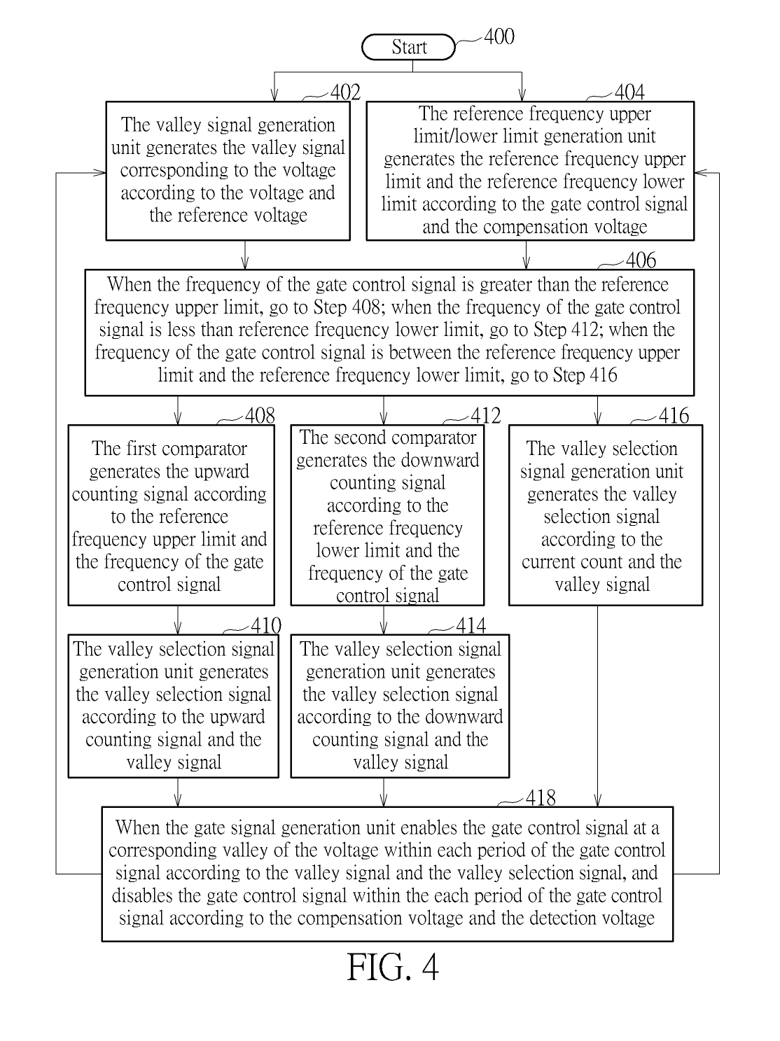

Please refer to FIG. 1, FIG. 2, FIG. 3, and FIG. 4. FIG. 4 is a flowchart illustrating a frequency control method of a power converter according to a second embodiment of the present invention. The method in FIG. 4 is illustrated using the power converter 100 and the frequency controller 200 in FIG. 1. Detailed steps are as follows:

Step 400: Start.

Step 402: The valley signal generation unit 202 generates the valley signal QRD corresponding to the voltage VD according to the voltage VD and the reference voltage VREF.

Step 404: The reference frequency upper limit/lower limit generation unit 2042 generates the reference frequency upper limit CLKH and the reference frequency lower limit CLKL according to the gate control signal GCS and the compensation voltage VCOMP.

Step 406: When the frequency of the gate control signal GCS is greater than the reference frequency upper limit CLKH, go to Step 408; when the frequency of the gate control signal GCS is less than reference frequency lower limit CLKL, go to Step 412; when the frequency of the gate control signal GCS is between the reference frequency upper limit CLKH and the reference frequency lower limit CLKL, go to Step 416.

Step 408: The first comparator 20442 generates the upward counting signal UPS according to the reference frequency upper limit CLKH and the frequency of the gate control signal GCS.

Step 410: The valley selection signal generation unit 20446 generates the valley selection signal QRSEL according to the upward counting signal UPS and the valley signal QRD, go to Step 418.

Step 412: The second comparator 20444 generates the downward counting signal DOWNS according to the reference frequency lower limit CLKL and the frequency of the gate control signal GCS.

Step 414: The valley selection signal generation unit 20446 generates the valley selection signal QRSEL according to the downward counting signal DOWNS and the valley signal QRD, go to Step 418.

Step 416: The valley selection signal generation unit 20446 generates the valley selection signal QRSEL according to the current count and the valley signal QRD, go to Step 418.

Step 418: When the gate signal generation unit 206 enables the gate control signal GCS at a corresponding valley of the voltage VD within each period of the gate control signal GCS according to the valley signal QRD and the valley selection signal QRSEL, and disables the gate control signal GCS within the each period of the gate control signal GCS according to the compensation voltage VCOMP and the detection voltage DV, go to Step 402 and Step 404.

In Step 402, as shown in FIG. 1, the valley signal generation unit 202 generates the valley signal QRD corresponding to the voltage VD according to the voltage VD received by the auxiliary pin 208 and the reference voltage VREF, wherein the voltage VD corresponds to the auxiliary winding AUX of the primary side PRI of the power converter 100, and is generated by the voltage divider 102 coupled to the auxiliary winding AUX.

In Step 404, as shown in FIG. 1, the reference frequency upper limit/lower limit generation unit 2042 can generate the reference frequency upper limit CLKH and the reference frequency lower limit CLKL according to the gate control signal GCS generated by the gate signal generation unit 206 and the compensation voltage VCOMP received by the compensation pin 210, wherein the compensation voltage VCOMP corresponds to the output voltage VOUT of the secondary side SEC of the power converter 100 (that is, the compensation voltage VCOMP corresponds to the load of the secondary side SEC of the power converter 100), and the reference frequency upper limit CLKH and the reference frequency lower limit CLKL are changed with the compensation voltage VCOMP.

In Step 408 and Step 410, as shown in FIG. 1 and FIG. 2, at the time T1, the load of the secondary side SEC of the power converter 100 is decreased, so the compensation voltage VCOMP is also decreased with the load of the secondary side SEC of the power converter 100. Because the load of the secondary side SEC of the power converter 100 is decreased, the sum of the turning-on time TON and the turning-off time TOFF corresponding to the period TM of the gate control signal GCS is less than the sum of the turning-on time TON and the turning-off time TOFF corresponding to the period TL of the gate control signal GCS. That is to say, after the time T1, the frequency of the gate control signal GCS is increased and exceeds the reference frequency upper limit CLKH, resulting in the first comparator 20442 of the valley selector 2044 generating the upward counting signal UPS. Therefore, the first counter 204462 can count upward once according to the upward counting signal UPS (meanwhile, the number stored in the first counter 204462 is “2”). After the time T2, because the number stored in the first counter 204462 is “2”, the valley decoder 204466 can generate the valley selection signal QRSEL (the position B shown in FIG. 2) after the first valley FV2 (corresponding to the time T3) of the voltage VD. That is to say, after the time T3, the valley decoder 204466 can generate the valley selection signal QRSEL after the first valley FV2 of the voltage VD according to the number “1” (corresponding to the first valley FV2 of the voltage VD) of the valley signal QRD recoded by the second counter 204464 and the number “2” stored in the first counter 204462. In Step 418, Because the valley decoder 204466 can generate the valley selection signal QRSEL after the first valley FV2 of the voltage VD, the gate signal generation unit 206 can enable the gate control signal GCS at the time T4 (corresponding to the second valley SV1 of the voltage VD) according to the valley signal QRD and the valley selection signal QRSEL. Because the gate signal generation unit 206 can enable the gate control signal GCS at the second valley SV1 (corresponding to the time T4) of the voltage VD according to the valley signal QRD and the valley selection signal QRSEL, the turning-off time TOFF corresponding to the period TM1 of the gate control signal GCS is increased. That is to say, the frequency of the gate control signal GCS will be less than the reference frequency upper limit CLKH after the time T2. However, after the time T2, if the frequency of the gate control signal GCS is still greater than the reference frequency upper limit CLKH, the frequency controller 200 can execute the above mentioned steps repeatedly until the frequency of the gate control signal GCS is less than the reference frequency upper limit CLKH. In addition, in Step 418, when the detection voltage DV is greater than or equal to the compensation voltage VCOMP, the gate signal generation unit 206 can disable the gate control signal GCS (e.g. the position A shown in FIG. 2) according to the compensation voltage VCOMP and the detection voltage DV.

In Step 412 and Step 414, as shown in FIG. 1 and FIG. 3, at the time T1, the load of the secondary side SEC of the power converter 100 is increased, so the compensation voltage VCOMP is also increased with the load of the secondary side SEC of the power converter 100. Because the load of the secondary side SEC of the power converter 100 is increased, the sum of the turning-on time TON and the turning-off time TOFF corresponding to the period TM of the gate control signal GCS is greater than the sum of the turning-on time TON and the turning-off time TOFF corresponding to the period TL of the gate control signal GCS. That is to say, after the time T1, the frequency of the gate control signal GCS is decreased and lower than the reference frequency lower limit CLKL, resulting in the second comparator 20444 of the valley selector 2044 generating the downward counting signal DOWNS. Therefore, the first counter 204462 can count downward once according to the downward counting signal DOWNS (before the time T1, because the gate signal generation unit 206 enables the gate control signal GCS at the third valley TV1 of the voltage VD, meanwhile, the number stored in the first counter 204462 is changed from “3” to “2”). After the time T2, because the number stored in the first counter 204462 is “2”, the valley decoder 204466 can generate the valley selection signal QRSEL (the position E shown in FIG. 3) after the first valley FV1 of the voltage VD. That is to say, after the time T3, the valley decoder 204466 can generate the valley selection signal QRSEL according to the number “1” (corresponding to the first valley FV1 of the voltage VD) of the valley signal QRD recoded by the second counter 204464 and the number “2” stored in the first counter 204462. In Step 418, as shown in FIG. 3, because the valley decoder 204466 can generate the valley selection signal QRSEL after the first valley FV1 of the voltage VD, the gate signal generation unit 206 can enable the gate control signal GCS at the time T4 (corresponding to the second valley SV1 of the voltage VD) according to the valley signal QRD and the valley selection signal QRSEL. Because the gate signal generation unit 206 can enable the gate control signal GCS at the second valley SV1 (corresponding to the time T4) of the voltage VD according to the valley signal QRD and the valley selection signal QRSEL, the turning-off time TOFF corresponding to the period TM1 of the gate control signal GCS is decreased. That is to say, the frequency of the gate control signal GCS will be greater than the reference frequency lower limit CLKL after the time T2. However, after the time T2, if the frequency of the gate control signal GCS is still less than the reference frequency lower limit CLKL the frequency controller 200 can execute the above mentioned steps repeatedly until the frequency of the gate control signal GCS is greater than the reference frequency lower limit CLKL.

In addition, in Step 416, when the load of the secondary side SEC of the power converter 100 is unchanged, the frequency of the gate control signal GCS is between the reference frequency upper limit CLKH and the reference frequency lower limit CLKL. Meanwhile, the valley decoder 204466 can generate the valley selection signal QRSEL according to the current count stored in the first counter 204462 and the number of the valley signal QRD recoded by the second counter 204464. For example, after the time T4 shown in FIG. 2, if the load of the secondary side SEC of the power converter 100 is unchanged, the frequency of the gate control signal GCS is between the reference frequency upper limit CLKH and the reference frequency lower limit CLKL. Because the frequency of the gate control signal GCS is between the reference frequency upper limit CLKH and the reference frequency lower limit CLKL, the valley decoder 204466 can generate the valley selection signal QRSEL after the first valley of the voltage VD according to the current count (that is, a number “2”) stored in the first counter 204462 and the number “1” (corresponding to the first valley of the voltage VD) of the valley signal QRD recoded by the second counter 204464. Similarly, as shown in FIG. 3, when the load of the secondary side SEC of the power converter 100 is unchanged, the frequency of the gate control signal GCS is between the reference frequency upper limit CLKH and the reference frequency lower limit CLKL. Meanwhile, the valley decoder 204466 can generate the valley selection signal QRSEL according to the current count stored in the first counter 204462 and the number of the valley signal QRD recoded by the second counter 204464. For example, after the time T4 shown in FIG. 3, if the load of the secondary side SEC of the power converter 100 is unchanged, the frequency of the gate control signal GCS is between the reference frequency upper limit CLKH and the reference frequency lower limit CLKL. Because the frequency of the gate control signal GCS is between the reference frequency upper limit CLKH and the reference frequency lower limit CLKL, the valley decoder 204466 can generate the valley selection signal QRSEL after the first valley of the voltage VD according to the current count (that is, a number “2”) stored in the first counter 204462 and the number “1” (corresponding to the first valley of the voltage VD) of the valley signal QRD recoded by the second counter 204464.

To sum up, the frequency controller of the power converter and the frequency control method of the power converter utilize the valley signal generation unit to generate the valley signal, utilize the reference frequency upper limit/lower limit generation unit to generate the reference frequency upper limit and the reference frequency lower limit changed with the compensation voltage according to the gate control signal and the compensation voltage, utilize the valley selector to generate the valley selection signal according to the reference frequency upper limit, the reference frequency lower limit, the valley signal, and the gate control signal, and utilize the gate signal generation unit to generate the gate control signal according to the valley signal, the valley selection signal, the compensation voltage, and the detection voltage. Because the valley selector generates the valley selection signal according to the reference frequency upper limit, the reference frequency lower limit, the valley signal, and the gate control signal, the frequency of the gate control signal generated by the gate signal generation unit can be adjusted gradually to be between the reference frequency upper limit and the reference frequency lower limit. Because the frequency of the gate control signal generated by the gate signal generation unit can be adjusted gradually to be between the reference frequency upper limit and the reference frequency lower limit, the present invention can solve a noise problem generated by the prior art when a light load is coupled to the power converter.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A frequency controller of a power converter, the frequency controller comprising:
a valley signal generation unit for generating a valley signal corresponding to a voltage according to the voltage and a reference voltage;
a valley selection module for generating a valley selection signal according to a gate control signal, a compensation voltage, and the valley signal; and
a gate signal generation unit for generating the gate control signal according to the valley signal, the valley selection signal, the compensation voltage, and a detection voltage, wherein a frequency of the gate control signal is changed with a corresponding valley of the voltage within each period of the gate control signal, and the corresponding valley is changed with a load of a secondary side of the power converter.

2. The frequency controller of claim 1, further comprising:
an auxiliary pin for receiving the voltage, wherein the voltage corresponds to an auxiliary winding of a primary side of the power converter.

3. The frequency controller of claim 1, further comprising:
a compensation pin for receiving the compensation voltage, wherein the compensation voltage corresponds to an output voltage of the secondary side of the power converter.

4. The frequency controller of claim 1, further comprising:
a gate pin, wherein the gate control signal is transmitted to a power switch of a primary side of the power converter through the gate pin.

5. The frequency controller of claim 1, wherein the valley selection module comprises:
a reference frequency upper limit/lower limit generation unit for generating a reference frequency upper limit and a reference frequency lower limit according to the gate control signal and the compensation voltage; and
a valley selector coupled to the reference frequency upper limit/lower limit generation unit and the valley signal generation unit for generating the valley selection signal according to the reference frequency upper limit, the reference frequency lower limit, the valley signal, and the gate control signal.

6. The frequency controller of claim 5, wherein the valley selector comprises:
a first comparator for generating an upward counting signal according to the reference frequency upper limit and a frequency of the gate control signal when the frequency of the gate control signal is greater than the reference frequency upper limit;
a second comparator for generating a downward counting signal according to the reference frequency lower limit and the frequency of the gate control signal when the frequency of the gate control signal is less than the reference frequency lower limit; and
a valley selection signal generation unit coupled to the first comparator, the second comparator, and the valley signal generation unit for generating the valley selection signal according to the upward counting signal and the valley signal, the downward counting signal and the valley signal, or a current count and the valley signal, wherein the current count is generated by a first counter of the valley selector.

7. The frequency controller of claim 5, wherein the reference frequency upper limit and the reference frequency lower limit are changed with the compensation voltage.

8. The frequency controller of claim 1, further comprising:
a current detection pin for receiving the detection voltage, wherein the detection voltage is determined by a current flowing through a power switch of a primary side of the power converter and a resistor.

9. The frequency controller of claim 1, wherein the compensation voltage corresponds to a load of the secondary side of the power converter.

10. The frequency controller of claim 1, wherein the gate signal generation unit enables the gate control signal at the corresponding valley of the voltage within the each period according to the valley signal and the valley selection signal, and disables the gate control signal within the each period according to the compensation voltage and the detection voltage.

11. A frequency control method of a power converter, wherein a frequency controller applied to the frequency control method comprises a valley signal generation unit, a valley selection module, and a gate signal generation unit, and the valley selection module comprises a reference frequency upper limit/lower limit generation unit and a valley selector, the frequency control method comprising:
the valley signal generation unit generating a valley signal corresponding to a voltage according to the voltage and a reference voltage;
the valley selection module generating a valley selection signal according to a gate control signal, a compensation voltage, and the valley signal; and
the gate signal generation unit generating the gate control signal according to the valley signal, the valley selection signal, the compensation voltage, and a detection voltage, wherein a frequency of the gate control signal is changed with a corresponding valley of the voltage within each period of the gate control signal, and the corresponding valley is changed with a load of a secondary side of the power converter.

12. The frequency control method of claim 11, wherein the voltage corresponds to an auxiliary winding of a primary side of the power converter.

13. The frequency control method of claim 11, wherein the compensation voltage corresponds to an output voltage of the secondary side of the power converter.

14. The frequency control method of claim 11, wherein the valley selection module generating the valley selection signal according to the gate control signal, the compensation voltage, and the valley signal comprises:
the reference frequency upper limit/lower limit generation unit generating a reference frequency upper limit and a reference frequency lower limit according to the gate control signal and the compensation voltage; and
the valley selector generating the valley selection signal according to the reference frequency upper limit, the reference frequency lower limit, the valley signal, and the gate control signal.

15. The frequency control method of claim 14, wherein the valley selector generating the valley selection signal according to the reference frequency upper limit, the reference frequency lower limit, the valley signal, and the gate control signal comprises:
generating an upward counting signal according to the reference frequency upper limit and a frequency of the gate control signal when the frequency of the gate control signal is greater than the reference frequency upper limit; and
generating the valley selection signal according to the upward counting signal and the valley signal.

16. The frequency control method of claim 14, wherein the valley selector generating the valley selection signal according to the reference frequency upper limit, the reference frequency lower limit, the valley signal, and the gate control signal comprises:
generating a downward counting signal according to the reference frequency lower limit and a frequency of the gate control signal when the frequency of the gate control signal is less than the reference frequency lower limit; and
generating the valley selection signal according to the downward counting signal and the valley signal.

17. The frequency control method of claim 14, wherein the valley selector generating the valley selection signal according to the reference frequency upper limit, the reference frequency lower limit, the valley signal, and the gate control signal comprises:
generating the valley selection signal according to a current count and the valley signal when a frequency of the gate control signal is between the reference frequency upper limit and the reference frequency lower limit.

18. The frequency control method of claim 11, wherein the reference frequency upper limit and the reference frequency lower limit are changed with the compensation voltage.

19. The frequency control method of claim 11, wherein the compensation voltage corresponds to the load of the secondary side of the power converter.

20. The frequency control method of claim 11, wherein the gate signal generation unit generating the gate control signal according to the valley signal, the valley selection signal, the compensation voltage, and the detection voltage comprises:
the gate signal generation unit enabling the gate control signal at the corresponding valley of the voltage within the each period according to the valley signal and the valley selection signal; and
the gate signal generation unit disabling the gate control signal within the each period according to the compensation voltage and the detection voltage.
